(19) United States
(12) Patent Application Publication
(10) Pub. No.: US 2007/0019441 A1
(43) Pub. Date: Jan. 25, 2007

(54) Slidable light body for track systems

(76) Inventor: Karren Moreland, Phoenix, AZ (US)

Correspondence Address: The Halvorson Law Firm, Ste 130, 1757 E. Baseline Rd., Gilbert, AZ, 85233, US

(21) Appl. No.: 11/186,456

(22) Filed: Jul. 21, 2005

(51) Int. Cl. H01R 33/00

(52) U.S. Cl. 362/648

(57) ABSTRACT

Disclosed is a clip useful for the moveably attaching items to a track system. The clip according to the present invention has a slideable body with an attached light item securing portion. The slidable body is preferably semi-spherical in shape with two opposed, cut-out sections. There is a downward portion that projects from the apex of the semi-spherical shape and attaches to the item securing portion, which includes a shoulder element that prevents unwanted inward movement of the clip relative to the interior of the track system. In one embodiment the item securing portion is first and second depending legs.

### FIELD OF THE INVENTION

The present invention relates to the field of clip devices designed for use with track system. More specifically the present invention relates to the field of slidable light bodies that movably secure light strings and are used with track systems.

### BACKGROUND

It has become common practice to decorate homes, businesses, or other buildings during holiday seasons, such as Christmas, Halloween, Easter, and the like, by attaching strings of lights to achieve a decorative effect. The strings of lights are typically secured beneath overhanging eaves and around gables, and are also positioned to outline architectural features, whether interior or exterior, of the homes and businesses, such as windows, doorways, bars, and the like.

The strings of lights are usually secured in place by simple connectors such as staples, hooks, nails and the like. This method however, due to repetitive installation and removal of the staples, results in considerable marring of the wooden mounting surfaces and also can be dangerous because of potential damage to light string wires. Staples and other sharp objects are not a recommended method of installation but lacking other convenient methods of light string installation are used by many.

Longs strings of lights, as are typically used, are difficult to install and consequently a householder is often inclined to leave the lights in place once they are secured. Although this avoids yearly installation and removal, the strings of lights are exposed to weather for the full year resulting in their early deterioration and, furthermore, they add nothing to, and in fact detract from, the appearance of a house between holiday seasons. Further, the permanently attached light strings may conveniently express only a single holiday.

Light holders have heretofore been devised for attachment to buildings for attaching strings of lights in a regular manner and which afford the light strings some protection from the weather. These light holders required periodic use of a ladder while installing and removing the holiday light strings. Alternately, if the lights are left in place, they are continuously exposed to view. Consequently, unless the homeowner is content to accept the detraction from the aesthetic qualities of this home, the holders must be installed and removed each holiday season, such as Christmas, Halloween, and the like.

### SUMMARY OF THE INVENTION

It is an object of the present invention to provide a slidable light body for securing lights from a light string to a track system.

The novel features that are considered characteristic of the invention are set forth with particularity in the appended claims. The invention itself, however, both as to its structure and its operation together with the additional objects and advantages thereof will best be understood from the following description of the preferred embodiment of the present invention when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6, are sought to be invoked to define the invention(s), the claims will specifically state the phrases “means for” or “step for” and a function, without also reciting in such phrases any structure, material, or act in support of the function. Even when the claims recite a “means for” or “step for” performing a function, if they also recite any structure, material or acts in support of that means of step, then the intention is not to invoke the provisions of 35 U.S.C. §112, paragraph 6. Moreover, even if the provisions of 35 U.S.C. §112, paragraph 6, are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, materials or acts for performing the claimed function.

### BRIEF DESCRIPTION OF THE DRAWINGS

FIG. 1 is a perspective view of the device according to the present invention showing an unlatched position.

FIG. 2 is a perspective view of the device according to the present invention showing an intermediate position.

FIG. 3 is a perspective view of the device according to the present invention showing a latched position.

FIG. 4 is an alternate embodiment of the device according to the present invention.

### DESCRIPTION OF PREFERRED EMBODIMENTS

Referring now to the figures, the present invention is a slidable light body 10 useful for the moveably attaching light elements 1 from a light string 2 to a track system.

The slidable light body 10 comprises a light element 1 containing body portion 12, which is a hollow or channeled body element that is capable of containing a light element 1 from a light string 2. There is a proximal aperture 14 through which the wires for the light string 2 for the light element 1 are inserted and a distal aperture 16, not fully illustrated, through which the light element 1 is inserted into the body portion 12. Located on opposite sides of the proximal aperture 14 are two shoulders, a first shoulder 20 and a second shoulder 22, which attaches either permanently or releasably to a cap section 24. The light element 1 containing body portion 12 further comprises two flat channel surfaces 13 (only one is shown in the figures) located on opposing sides of the light element 1 containing body portion 12 that provide convenient finger grips when removing or inserting a light element 1 from the body portion 12.

Attached to a top surface 27 of the cap section 24 is a slideable body 28. The slidable body 28 is preferably semi-spherical in shape with two opposed, cut-out sections 30. There is a downward portion 32 that projects from the apex of the semi-spherical slidable body 28 and attaches to the top surface 27 of the cap section 24. Additionally, the downward portion 32 that projects from the apex of the slidable body 28 may include an articulated joint (not shown). The articulated joint is used to provide additional flexibility in the positioning of mounted light strings 2.

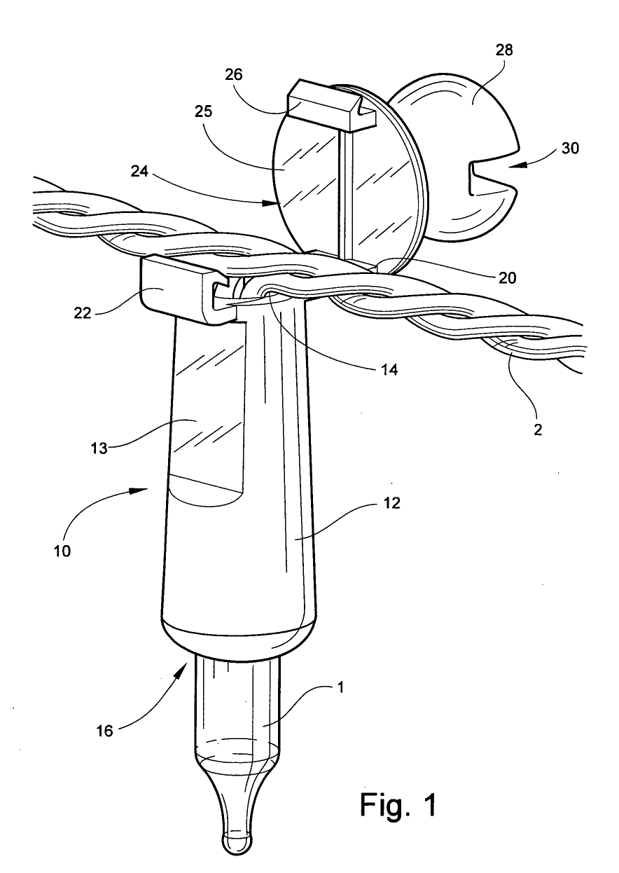

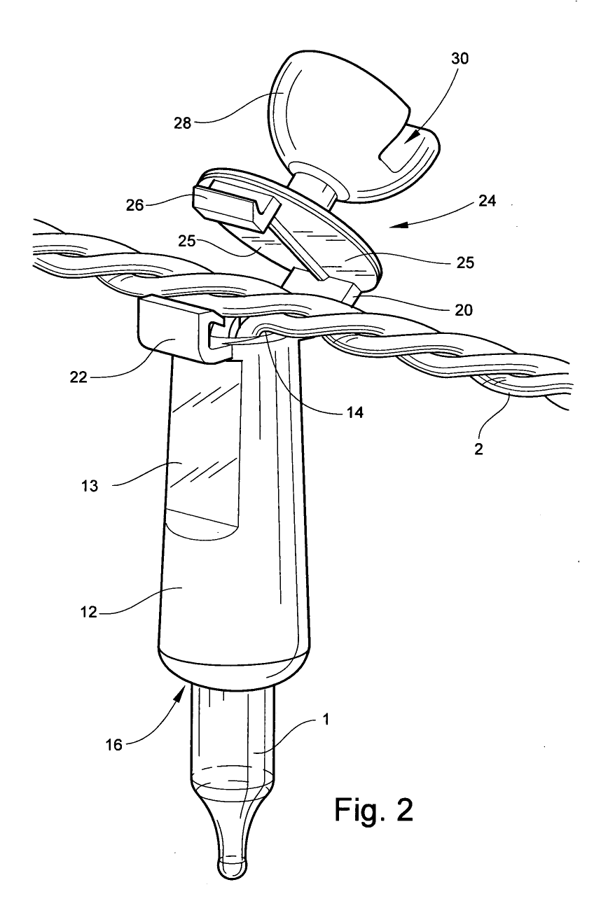

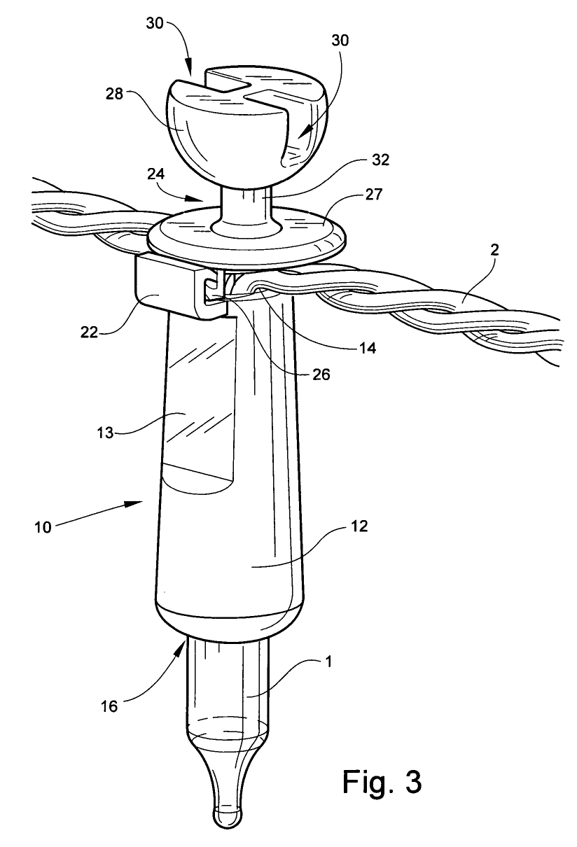

In a first embodiment, illustrated in FIGS. 1-3, the first shoulder 20 is flexibly attached to the cap section 24. The second shoulder 22 is shaped to receive a barbed hook element 26 (generally J-shaped in cross section). The cap section 24 has a barbed hook element 26 located on a bottom surface 25 of the cap section 24. This hook element 26 is positioned such that it is receivable by the second shoulder 22, thereby latching the cap section 24 to the light element 1 containing body portion 12.

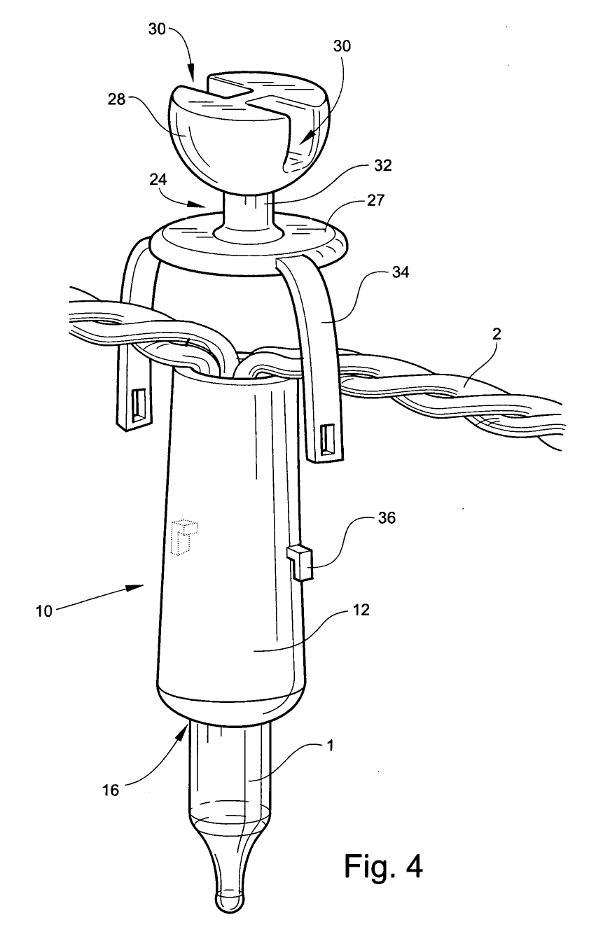

In an alternate embodiment, illustrated in FIG. 4, the cap section 24 is a separate piece that has two downward projecting tangs 34 that receive barbs 36 located on the first and second shoulders, 20 and 22.

In yet another alternate embodiment, the slidable body 28 is attached directly to the hollow body portion 12 directly by the downward portion 32.

In use a light element 1 is inserted into the distal aperture 16, through the hollow body 1 until it contacts the light string wire 2. The cap section 24 is then taken from an unlatched position to a latched position where the barbed hook element 26 is engaged by the second shoulder 22, thereby securing the light string 2 into the hollow body 12 (or in the alternate embodiment both downwardly projecting tangs are secured to the barbs on the first and second shoulders, 20 and 22. The slidable body 28 is then inserted in a track system for easy and convenient movement of the contained light element 1 and light string 2 along the track system.

The preferred embodiment of the invention is described above in the Drawings and Description of Preferred Embodiments. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A slidable light body for slidably mounting a light to a track system comprising a hollow body portion having a proximal aperture and a distal aperture, first and second shoulders located adjacent to the proximal aperture, a cap section that attaches to the first and second shoulders, and a slidable body attached to a top surface of the cap section by a downward portion that projects from the apex of the slidable body.

2. The slidable light body of claim 1 wherein the slidable body further comprises at least one cut-out section in the slidable body.

3. The slidable light body of claim 1 wherein the body element further comprises two flat channel surfaces located on opposing sides of the body portion.

4. The slidable light body of claim 1 where the cap section is flexibly attached to at least one shoulder and releasably attachable to the remaining shoulder element.

5. The slidable light body of claim 4 wherein the slidable body further comprises at least one cut-out section in the slidable body.

6. The slidable light body of claim 4 wherein the body element further comprises two flat channel surfaces located on opposing sides of the body portion.

7. The slidable light body of claim 1 where the cap section is releasably attachable to both shoulder elements.

8. The slidable light body of claim 6 wherein the slidable body further comprises at least one cut-out section in the slidable body.

9. The slidable light body of claim 6 wherein the body element further comprises two flat channel surfaces located on opposing sides of the body portion.

10. The slidable light body of claim 1 where the cap section is permanently attached to both shoulder elements.

11. The slidable light body of claim 10 wherein the slidable body further comprises at least one cut-out section in the slidable body.

12. The slidable light body of claim 10 wherein the body element further comprises two flat channel surfaces located on opposing sides of the body portion.

13. A slidable light body for slidably mounting a light to a track system comprising a hollow body portion having a proximal aperture and a distal aperture and a slidable body attached to a surface of the body portion by a downward portion that projects from the apex of the slidable body.
